(19) United States
(12) Patent Application Publication
(10) Pub. No.: US 2013/0061675 A1
(43) Pub. Date: Mar. 14, 2013

(54) ACCELERATION MEASURING APPARATUS AND ACCELERATION MEASURING METHOD

(71) Applicants: Sung Tae Kim, Gyeonggi-do (KR); Chang Hyun Kim, Gyeonggi-do (KR)

(72) Inventors: Sung Tae Kim, Gyeonggi-do (KR); Chang Hyun Kim, Gyeonggi-do (KR)

(21) Appl. No.: 13/595,990

(22) Filed: Aug. 27, 2012

(30) Foreign Application Priority Data
Sep. 9, 2011 (KR) 10-2011-0091835

(51) Int. Cl. G01P 15/12

(52) U.S. Cl. 73/514.33

(57) ABSTRACT

Disclosed herein are an acceleration measuring apparatus and an acceleration measuring method. The acceleration measuring apparatus includes: an acceleration sensor including a first output terminal and a second output terminal; a first switch of which an end is connected to the first output terminal; a second switch of which an end is connected to the second output terminal; a first resistor of which an end is connected to the other end of the first switch; a second resistor of which an end is connected to the other end of the second switch; a logic element connected to the end of the first resistor and the end of the second resistor; and a Time-to-Digital Convertor (TDC) converting a signal output from the logic element into a digital value.

### CROSS REFERENCE(S) TO RELATED APPLICATIONS

This application claims the benefit under 35 U.S.C. Section 119 of Korean Patent Application Serial No. 10-2011-0091835 entitled “Acceleration Measuring Apparatus And Acceleration Measuring Method” filed on Sep. 9, 2011, which is hereby incorporated by reference in its entirety into this application.

### BACKGROUND OF THE INVENTION

1. Technical Field

The present invention relates to an acceleration measuring apparatus and an acceleration measuring method, and more particularly, to an acceleration measuring apparatus and an acceleration measuring method, which may process, in a digital scheme, a signal output from a sensor, and outputs the processed signal.

2. Description of the Related Art

An acceleration sensor or a gyro sensor may be a sensor that detects acceleration, gravity, and the like, of an object, and detect instantaneous operations.

These sensors have already been used in large equipment such as an automobile, and the like, and the size and the power consumption of the sensor are significantly reduced due to using an MEMS (Micro Electro Mechanical Systems) technology that is applied to the sensor. Therefore, various applications of the sensor have been proposed in a manner such that shake correction function of a digital camera is realized, or acceleration, and the like, of various mobile devices such as a smart phone, and the like are measured.

Meanwhile, an acceleration sensor may be realized in a variety of types, and as the representative scheme thereof, a capacitance type and a piezoresistive type are given.

As for the capacitance type, acceleration is detected using a principle in which a distance between a moving electrode and a fixed electrode is changed when acceleration is generated, and accordingly, a capacitance is changed.

In a general acceleration sensor related technologies in the related art, signals output from the acceleration sensor is processed in an analog manner to thereby be digitized.

For example, a scheme in which charge signals are converted into voltage signals through a charge amp, and the like, the voltage signals are amplified, the amplified signals are filtered, and then the filtered signals processed by an ADC (Analog-Digital Converter) have been mainly used.

However, in the above described scheme in the related art, power consumption is large, and a separate configuration for removing noise is required, so that there is a limitation in the miniaturization and reduction in power consumption.

In Patent Document 1, the representative capacitance type acceleration detection device has been disclosed.

However, in the technology disclosed in Patent Document 1, even though an amplifier, a filter, and the like are included, this analog scheme does not overcome the above described problems that occur due to the size and the power consumption.

### RELATED ART DOCUMENT

### Patent Document

(Patent Document 1) U.S. Pat. No. 5,831,164

### SUMMARY OF THE INVENTION

An object of the present invention is to provide an acceleration measuring device and an acceleration measuring method, which may generate a pulse signal having a pulse width corresponding to a change in a capacitance generated in an acceleration sensor using the change in capacitance, and convert the generated pulse signal into a digital value to be output.

According to an exemplary embodiment of the present invention, there is provided an acceleration measuring apparatus, including: an acceleration sensor including a first output terminal and a second output terminal; a first switch of which an end is connected to the first output terminal; a second switch of which an end is connected to the second output terminal; a first resistor of which an end is connected to the other end of the first switch; a second resistor of which an end is connected to the other end of the second switch; a logic element connected to the end of the first resistor and the end of the second resistor; and a Time-to-Digital Convertor (TDC) converting a signal output from the logic element into a digital value.

In this instance, the logic element may be any one of selected from an XOR gate, a flip-flop, and a latch.

Also, the acceleration measuring apparatus may further include a first compensation capacitor of which one end is connected between the first output terminal and the first switch, and the other end is grounded, and a second compensation capacitor of which one end is connected between the second output terminal and the second switch, and the other end is grounded.

Also, the acceleration measuring apparatus may further include a driving power source providing power to the acceleration sensor, and a power switch positioned between the driving power source and the acceleration sensor. Here, the power switch may be turned off when the first switch and the second switch are turned on.

Also, the acceleration sensor may include a moving terminal between two fixed terminals, and the moving terminal is moved between the two fixed terminals along a positional movement of the acceleration sensor.

Also, the acceleration measuring apparatus may further include a first inverter connected to the end of the first resistor, a second inverter connected to the end of the second resistor, a first AND gate in which an output terminal of the first inverter and an output terminal of the logic element are connected to an input terminal, and a second AND gate in which an output terminal of the second inverter and the output terminal of the logic element are connected to the input terminal.

Also, the logic element may compare a first signal generated when a signal output through the first switch is applied to the first resistor, and a second signal generated when a signal output through the second switch is applied to the second resistor to output the compared result.

In this instance, a signal output from the logic element may be a pulse signal.

According to another exemplary embodiment of the present invention, there is provided an acceleration measuring method in which acceleration information is output as a digital value using an acceleration measuring apparatus that includes an acceleration sensor including a first output terminal and a second output terminal; a first switch of which an end is connected to the first output terminal; a second switch of which an end is connected to the second output terminal; a first resistor of which an end is connected to the other end of the first switch; a second resistor of which an end is connected to the other end of the second switch; a logic element connected to the end of the first resistor and the end of the second resistor; and a TDC converting a signal output from the logic element into a digital value, the acceleration measuring method including: applying a driving power to the acceleration sensor; turning off the driving power, and turning on the first switch and the second switch; comparing, by the logic element, a first signal generated when a signal output through the first switch is applied to the first resistor and a second signal generated when a signal output through the second switch is applied to the second resistor to output the compared result as a pulse signal; and counting the signal output from the comparing in the TDC to output the counted signal as a digital value.

In this instance, the acceleration measuring apparatus may further include a first inverter connected to the end of the first resistor, a second inverter connected to the end of the second resistor, a first AND gate in which an output terminal of the first inverter and an output terminal of the logic element are connected to an input terminal, and a second AND gate in which an output terminal of the second inverter and the output terminal of the logic element are connected to the input terminal. Also, the acceleration measuring method may further include comparing a signal output from the first AND gate and a signal output from the second AND gate to thereby determine a direction of the acceleration.

According to another exemplary embodiment of the present invention, there is provided an acceleration measuring method, including: determining a first capacitance and a second capacitance in accordance with acceleration detected in an acceleration sensor; outputting a first signal attenuated in accordance with a first time constant that is determined by the first capacitance and a predetermined resistance value, and a second signal attenuated in accordance with a second time constant that is determined by the second capacitance and the predetermined resistance value; comparing the first signal and the second signal to thereby determine a pulse width; and counting the pulse width determined by comparing o the first signal and the second signal to output the counted pulse width as a digital value.

### BRIEF DESCRIPTION OF THE DRAWINGS

FIG. 1 is a block diagram schematically showing an acceleration measuring apparatus according to an exemplary embodiment of the present invention;

FIG. 2 is a diagram showing a configuration example of an acceleration sensor according to an exemplary embodiment of the present invention;

FIG. 3 is a circuit diagram showing an acceleration measuring apparatus according to an exemplary embodiment of the present invention;

FIG. 4 is a diagram for explaining a generation principle of a pulse signal according to an exemplary embodiment of the present invention;

FIG. 5 is a circuit diagram showing an acceleration measuring apparatus according to an exemplary embodiment of the present invention; and

FIG. 6 is a diagram for explaining a generation principle of a pulse signal and a determination principle of an acceleration direction according to an exemplary embodiment of the present invention.

### DESCRIPTION OF THE PREFERRED EMBODIMENTS

Various advantages and features of the present invention and methods accomplishing thereof will become apparent from the following description of embodiments with reference to the accompanying drawings. However, the present invention may be modified in many different forms and it should not be limited to the embodiments set forth herein. These embodiments may be provided so that this disclosure will be thorough and complete, and will fully convey the scope of the invention to those skilled in the art. Like reference numerals throughout the description denote like elements.

Terms used in the present specification are for explaining the embodiments rather than limiting the present invention. Unless explicitly described to the contrary, a singular form includes a plural form in the present specification. The word “comprise” and variations such as “comprises” or “comprising,” will be understood to imply the inclusion of stated constituents, steps, operations and/or elements but not the exclusion of any other constituents, steps, operations and/or elements.

Hereinafter, a configuration and an acting effect of exemplary embodiments of the present invention will be described in more detail with reference to the accompanying drawings.

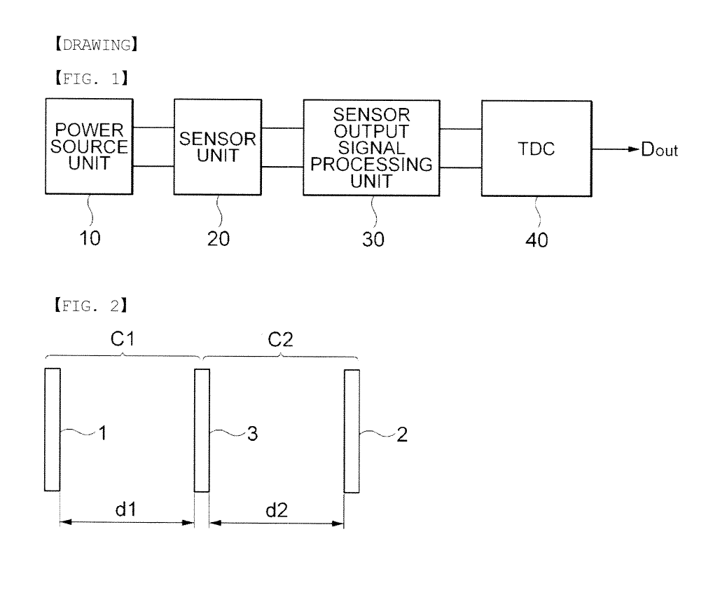

FIG. 1 is a block diagram schematically showing an acceleration measuring apparatus according to an exemplary embodiment of the present invention.

Referring to FIG. 1, the acceleration measuring apparatus according to the exemplary embodiment may include a power source unit 10, a sensor unit 20, a sensor output signal processing unit 30, and a Time-to-Digital Convertor 40 (TDC).

The power source unit 10 may apply a driving power source (VDD) to the sensor unit 20.

The sensor unit 20 may be implemented as a general capacitance type acceleration sensor.

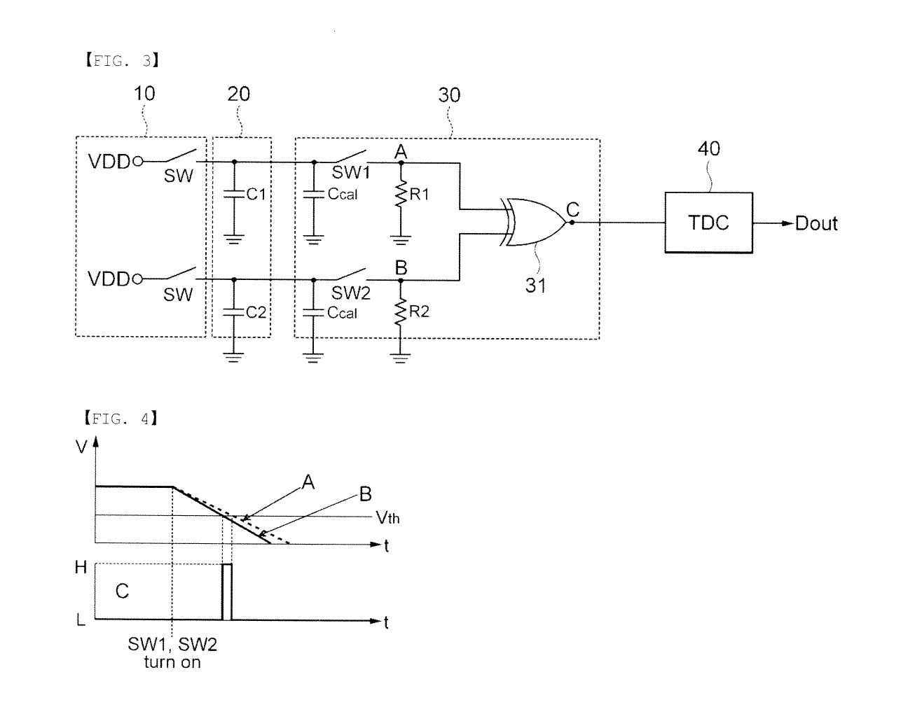

FIG. 2 is a diagram showing a configuration example of an acceleration sensor according to an exemplary embodiment of the present invention.

Referring to FIG. 2, the capacitance type acceleration sensor may include a first terminal 1 and a second terminal 2, which are a fixed terminal, and further include a moving terminal 3 provided between the first terminal 1 and the second terminal 2. Here, a position of the moving terminal 3 is changed when acceleration is generated.

For example, when acceleration is not generated, a distance d1 between the first terminal 1 and the moving terminal 3 and a distance d2 between the second terminal 2 and the moving terminal 3 are the same, so that a capacitance of a first capacitor C1 generated between the first terminal 1 and the moving terminal 3 and a capacitance of a second capacitor C2 generated between the second terminal 2 and the moving terminal 3 are the same. As a result, a change in the capacitance does not occur.

However, in the case in which acceleration is generated, for example, when the acceleration sensor is moved in a direction of the second terminal 2, the moving terminal 3 is moved to a position close to the first terminal 1, so that d1<d2 is satisfied. As a result, a capacitance of C1=Cs+ΔCa, and a capacitance of C2=Cs−ΔCa are satisfied (Here, Cs being a capacitance when acceleration is not generated, and ΔCa being a change amount of a capacitance generated in accordance with the movement of the moving terminal 3 when acceleration is generated). That is, the capacitance is changed.

The present invention is to use the change in the capacitance.

Accordingly, the sensor unit 20 may be the acceleration sensor including the first terminal 1, the second terminal 2, and the moving terminal 3.

The sensor output signal processing unit 30 may process a signal output from the sensor unit 20 to generate a pulse signal, and the detailed configuration thereof will be described in detail with reference to FIG. 3.

Meanwhile, the TDC 40 may count the pulse signal generated in the sensor output signal processing unit 30 in a fixed cycle, and output the counted signal as a digital value. That is, the digital value output in the TDC 40 may denote the magnitude of acceleration.

FIG. 3 is a circuit diagram showing an acceleration measuring apparatus according to an exemplary embodiment of the present invention.

Referring to FIG. 3, the power source unit 10 may include a driving power source (VDD), and a power switch (SW) applying the driving power.

Meanwhile, the sensor unit 20 may be implemented, as shown in FIG. 2, including two fixed terminals and a single moving terminal 3, and may be an equivalent circuit, as shown in FIG. 3, including the first capacitor C1 of which an end is grounded and the other end is connected to a first output terminal, and the second capacitor C2 of which an end is grounded and the other end is connected to a second output terminal.

Next, the sensor output signal processing unit 30 may include a first switch (SW1), a second switch (SW2), a first resistor (R1), a second resistor (R2), and a logic element.

An end of the first switch (SW1) is connected to the first output terminal of the sensor unit 20, and the other end thereof is connected to the first resistor (R1).

An end of the second switch (SW2) is connected to the second output terminal of the sensor unit 20, and the other end thereof is connected to the second resistor (R2).

In this instance, the first switch (SW1) and the second switch (SW2) may be controlled to be turned on/off correspondingly with the power switch (SW) of the above described power source unit 10.

That is, the first switch (SW1) and the second switch (SW2) are turned off in a state in which the power switch (SW) is turned on, and the first switch (SW1) and the second switch (SW2) are turned on in a state in which the power switch (SW) is turned off.

In the logic element, an end of the first resistor (R1) and an end of the second resistor (R2) are respectively connected to an input terminal, so that a voltage signal of an A node and a voltage signal of a B node are input to the logic element.

Meanwhile, in FIG. 3, an example in which the logic element is implemented as an XOR gate 31 is described; however, the present invention is not limited thereto. Here, the logic element may be implemented as a flip-flop, a latch, and the like.

The logic element may compare the voltage signal of the A node and the voltage signal of the B node to thereby output the compared result. In this instance, the compared result may be output as a pulse signal.

Next, the signal output from the logic element may be counted in a fixed cycle by the TDC 40 to thereby output as a digital value.

Meanwhile, each of the capacitors C1 and C2 of the sensor unit 10 generally has a predetermined characteristic deviation in accordance with the manufacturing process; however, the characteristic deviation is required to be corrected to more accurately measure acceleration.

Therefore, the acceleration measuring apparatus according to an exemplary embodiment of the present invention may further include a first compensation capacitor (Ccal) of which an end is connected between the first output terminal and the first switch (SW1) and the other end is grounded, and a second compensation capacitor (Ccal) of which an end is connected between the second output terminal and the second switch (SW2) and the other end is grounded. The first compensation capacitor (Ccal) and the second compensation capacitor (Ccal) may be physically implemented in an actual circuit, or reflected in an operation process.

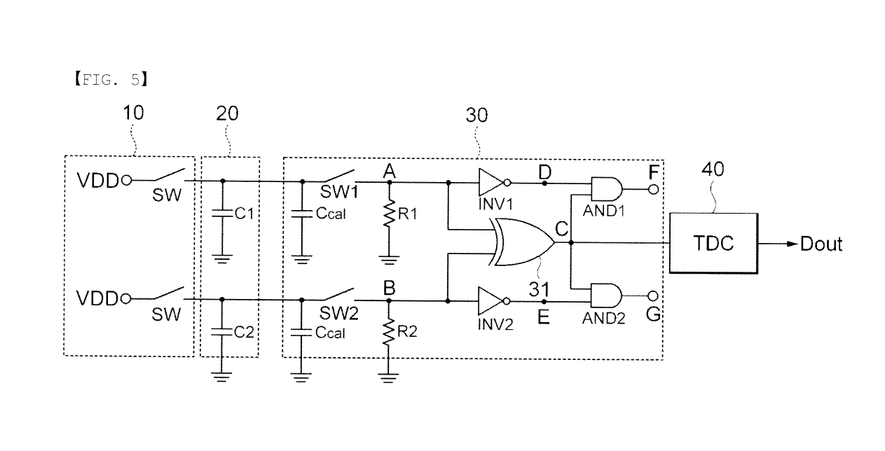

FIG. 4 is a diagram for explaining a generation principle of a pulse signal according to an exemplary embodiment of the present invention.

Referring to FIG. 4, when acceleration is generated, capacitance of the first capacitor (C1) and the second capacitor (C2) may be changed.

For example, when the acceleration sensor is moved in a direction of the second terminal 2, the moving terminal 3 is moved to a position close to the first terminal 1, so that d1<d2 is satisfied. As a result, the capacitance of C1=Cs+ΔCa, and the capacitance of C2=Cs−ΔCa (Here, Cs being the capacitance when acceleration is not generated, and ΔCa being a change amount of the capacitance generated in accordance with the movement of the moving terminal 3 when acceleration is generated) are satisfied.

Meanwhile, the first capacitor (C1) and the second capacitor (C2) are charged with electric charges in a state in which the power source unit 10 applies the driving power source (VDD) to the sensor unit 20. Here, when the first switch (SW1) and the second switch (SW2) are turned on in a state in which the driving power source (VDD) is blocked, the electric charges charged in the first capacitor (C1) flow into a ground terminal via the first resistor (R1) to thereby generate a first signal in the A node, and the electric charges charged in the second capacitor (C2) flow into the ground terminal via the second resistor (R2) to thereby generate a second signal in the B node.

In this instance, the time required for the electric charges charged in the first capacitor (C1) and the second capacitor (C2) to be discharged may be represented by a time constant, and the time constant may be determined as below.

τ1=R1*C1=R1*(Cs+ΔCa) and

τ2=R2*C2=R2*(Cs−ΔCa).

Here, τ1 denotes a time constant in a case in which the electric charges charged in the first capacitor (C1) is discharged via the first resistor (R1), and τ2 denotes a time constant in a case in which the electric charges charged in the second capacitor (C2) is discharged via the second resistor (R2).

Meanwhile, when it is assumed that R1 and R2 are the same, τ1>τ2 may be satisfied, and thereby the first signal and the second signal may be attenuated with mutually different slopes as shown in FIG. 4. That is, the voltage signal of the A node corresponding to the first signal is attenuated with a more gentle slope than that of the voltage signal of the B node corresponding to the second signal.

In this instance, when the first signal and the second signal are input to the logic element, and only one of the first signal and the second signal is smaller than a predetermined reference value (Vth), a high signal (H) is output, and when both the first signal and the second signal are greater than or smaller than the reference value (Vth), a low signal (L) is output, so that a pulse signal is output to a C node that is an output terminal of the logic element, as shown in FIG. 4. Here, as a difference between τ1 and τ2 is large, that is, as the magnitude of acceleration is large, a length of an H interval of the pulse signal output to the C node may be increased.

Accordingly, by counting the H interval of the pulse signal using the TDC 40, the magnitude of acceleration may be output as a digital value.

Meanwhile, the predetermined reference value may be changed in accordance with characteristics of the logic element.

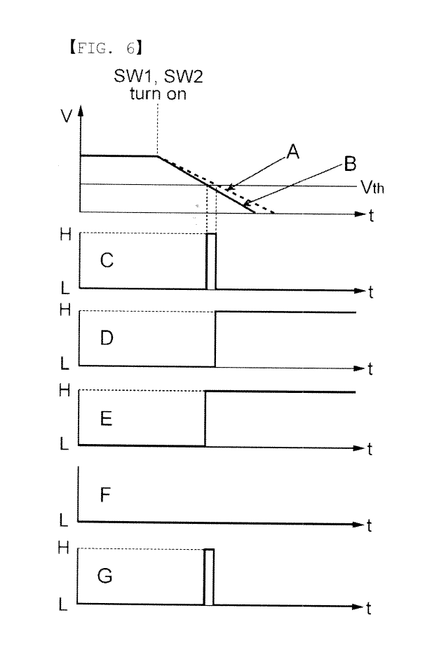

FIG. 5 is a circuit diagram showing an acceleration measuring apparatus according to an exemplary embodiment of the present invention, and FIG. 6 is a diagram for explaining a generation principle of a pulse signal and a determination principle of an acceleration direction according to an exemplary embodiment of the present invention.

Referring to FIG. 5, the acceleration measuring apparatus according to an exemplary embodiment of the present invention shown in FIG. 3 may further include two inverters (INV1 and INV2) and two AND gates (AND1 and AND2).

The first inverter (INV1) may be connected to an end of the first resistor (R1) to receive the first signal, and subjected to inverting, and the second inverter (INV2) may be connected to an end of the second resistor (R2) to receive the second signal, and subjected to inverting.

A value output from the first inverter (INV1) is input to the first AND gate (AND1), and a value output from the second inverter (INV2) is input to the second AND gate (AND2). Also, a signal output from the XOR gate 31 may be input to the first AND gate (AND1) and the second AND gate (AND2).

Accordingly, the first AND gate (AND1) may perform an AND operation on the value output from the first inverter (INV1) and the value output from the XOR gate 31 to thereby output the result, and the second AND gate (AND2) may perform an AND operation on the value output from the second inverter (INV2) and the value output from the XOR gate 31 to thereby output the result.

Referring to FIG. 6, when the sensor unit 20 is moved in a direction of the second terminal 2, the first AND gate (AND1) may perform an AND operation on the pulse signal output from the C node and a signal output from a D node that is an output terminal of the first inverter (INV1) to thereby output the result to an F node.

In addition, when the sensor unit 20 is moved in the direction of the second terminal 2, the second AND gate (AND2) may perform an AND operation on the pulse signal output from the C node and a signal output from an E node that is an output terminal of the second inverter (INV2) to thereby output the result to a G node.

It may be found that an H signal exists in a waveform of the G node when comparing a waveform of the F node and the waveform, of the G node.

Accordingly, it may be determined that acceleration is generated in accordance with the movement of which the sensor unit 20 is moved in the direction of the second terminal 2.

The acceleration measuring method according to an exemplary embodiment of the present invention may be a method for measuring acceleration using the above described acceleration measuring apparatus. The acceleration measuring method may start by applying a driving power to the acceleration sensor and charging the first capacitor and the second capacitor with electric charges.

Next, when the driving power is turned off, and the first switch (SW1) and the second switch (SW2) are turned on, the electric charges are discharged at mutually different speeds in accordance with difference in sizes of the first capacitor and the second capacitor.

Next, the first signal and the second signal, which are voltage signals of the A node and the B node in accordance with the discharge of the electric charges, are compared in the logic element to thereby output the pulse signal to the C node.

Next, the TDC may count the pulse signal output to the C node to thereby output the counted signal as a digital value, so that the magnitude of acceleration may be output as the digital value.

In this instance, when the acceleration measuring apparatus includes the above described components for direction determination, the movement direction of the sensor may be determined by comparing a waveform of an output signal of the F node that is an output node of the first AND gate (AND1) and a waveform of an output signal of the G node that is an output node of the second AND gate (AND2).

On the other hand, the acceleration measuring method according to an exemplary embodiment of the present invention may include determining a first capacitance and a second capacitance in accordance with acceleration detected in an acceleration sensor; outputting a first signal attenuated in accordance with a first time constant that is determined by the first capacitance and a predetermined resistance value, and a second signal attenuated in accordance with a second time constant that is determined by the second capacitance and the predetermined resistance value; comparing the first signal and the second signal to thereby determine a pulse width; and counting the determined pulse width to thereby output the counted pulse width as a digital value.

As set forth above, the acceleration measuring apparatus and the acceleration measuring method according to the exemplary embodiments of the present invention may output acceleration information as a digital value without a separate analog amplifier or a filter, thereby realizing miniaturization, and reducing power consumption in comparison with the related art.

The above detailed description exemplifies the present invention. Further, the above contents just illustrate and describe preferred embodiments of the present invention and the present invention can be used under various combinations, changes, and environments. That is, it will be appreciated by those skilled in the art that substitutions, modifications and changes may be made in these embodiments without departing from the principles and spirit of the general inventive concept, the scope of which is defined in the appended claims and their equivalents. Although the exemplary embodiments of the present invention have been disclosed for illustrative purposes, those skilled in the art will appreciate that various modifications, additions and substitutions are possible, without departing from the scope and spirit of the invention as disclosed in the accompanying claims. Therefore, the detailed description of the present invention does not intend to limit the present invention to the disclosed embodiments. Further, it should be appreciated that the appended claims may include even another embodiment.

What is claimed is:

1. An acceleration measuring apparatus, comprising:
an acceleration sensor including a first output terminal and a second output terminal;
a first switch of which an end is connected to the first output terminal;
a second switch of which an end is connected to the second output terminal;
a first resistor of which an end is connected to the other end of the first switch;
a second resistor of which an end is connected to the other end of the second switch;
a logic element connected to the end of the first resistor and the end of the second resistor; and
a Time-to-Digital Convertor (TDC) converting a signal output from the logic element into a digital value.

2. The acceleration measuring apparatus according to claim 1, wherein the logic element is any one selected from an XOR gate, a flip-flop, and a latch.

3. The acceleration measuring apparatus according to claim 1, further comprising:
a first compensation capacitor of which one end is connected between the first output terminal and the first switch, and the other end is grounded; and
a second compensation capacitor of which one end is connected between the second output terminal and the second switch, and the other end is grounded.

4. The acceleration measuring apparatus according to claim 1, they comprising:
a driving power source providing power to the acceleration sensor; and
a power switch positioned between the driving power source and the acceleration sensor,
wherein the power switch is turned off when the first switch and the second switch are turned on.

5. The acceleration measuring apparatus according to claim 1, wherein the acceleration sensor includes a moving terminal between two fixed terminals, and the moving terminal is moved between the two fixed terminals along a positional movement of the acceleration sensor.

6. The acceleration measuring apparatus according to claim 1, further comprising:
a first inverter connected to the end of the first resistor;
a second inverter connected to the end of the second resistor;
a first AND gate in which an output terminal of the first inverter and an output terminal of the logic element are connected to an input terminal; and
a second AND gate in which an output terminal of the second inverter and the output terminal of the logic element are connected to the input terminal.

7. The acceleration measuring apparatus according to claim 1, wherein the logic element compares a first signal generated when a signal output through the first switch is applied to the first resistor and a second signal generated when a signal output through the second switch is applied to the second resistor to output the compared result.

8. The acceleration measuring apparatus according to claim 7, wherein the logic element compares the first signal and the second signal to output a pulse signal.

9. An acceleration measuring method in which acceleration information is output as a digital value using an acceleration measuring apparatus that includes an acceleration sensor including a first output terminal and a second output terminal; a first switch of which an end is connected to the first output terminal; a second switch of which an end is connected to the second output terminal; a first resistor of which an end is connected to the other end of the first switch; a second resistor of which an end is connected to the other end of the second switch; a logic element connected to the end of the first resistor and the end of the second resistor; and a TDC converting a signal output from the logic element into a digital value, the acceleration measuring method comprising:
applying a driving power to the acceleration sensor;
turning off the driving power, and turning on the first switch and the second switch;
comparing, by the logic element, a first signal generated when a signal output through the first switch is applied to the first resistor and a second signal generated when a signal output through the second switch is applied to the second resistor to thereby output the compared result as a pulse signal; and
counting the signal output from the comparison in the TDC to thereby output the counted signal as a digital value.

10. The acceleration measuring method according to claim 9, wherein the acceleration measuring apparatus further includes a first inverter connected to the end of the first resistor; a second inverter connected to the end of the second resistor; a first AND gate in which an output terminal of the first inverter and an output terminal of the logic element are connected to an input terminal; and a second AND gate in which an output terminal of the second inverter and the output terminal of the logic element are connected to the input terminal,
the method further comprising:
comparing a signal output from the first AND gate and a signal output from the second AND gate to thereby determine a direction of the acceleration.

11. An acceleration measuring method, comprising:
determining a first capacitance and a second capacitance in accordance with acceleration detected in an acceleration sensor;
outputting a first signal attenuated in accordance with a first time constant that is determined by the first capacitance and a predetermined resistance value, and a second signal attenuated in accordance with a second time constant that is determined by the second capacitance and the predetermined resistance value;
comparing the first signal and the second signal to thereby determine a pulse width; and
counting the pulse width determined by comparing the first signal and the second signal to thereby output the counted pulse width as a digital value.
